(19) United States
(12) Patent Application Publication
(10) Pub. No.: US 2008/0211363 A1
(43) Pub. Date: Sep. 4, 2008

(54) Safety cabinet

(75) Inventors: Glen Alan Carter, Mattoon, IL (US); Steven Michael Eyer, Charleston, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Justrite Manufacturing Company, Des Plaines, IL (US)

(21) Appl. No.: 11/799,446

(22) Filed: May 1, 2007

Related U.S. Application Data
(63) Continuation of application No. 11/593,422, filed on Nov. 6, 2006.
(60) Provisional application No. 60/779,591, filed on Mar. 6, 2006.

(51) Int. Cl. A47B 96/00; E05C 9/18

(52) U.S. Cl. 312/216; 312/319.1

(57) ABSTRACT

A safety cabinet is disclosed which includes an enclosure having a double-walled construction and a pair of doors to selectively seal the enclosure. The safety cabinet includes a lock bar and a pair of retaining arms that permit the lock bar to be set across the front of the safety cabinet, thereby preventing the safety cabinet doors from being opened. The lock bar may be locked in place at both ends to the retaining arms by use of removable locks. When locked in place, the lock bar protects the safety cabinet from accidental or unauthorized opening. The enclosure is mounted on top of a base that contains two forklift pockets designed to accommodate the fork of a forklift. An indicator is disposed on the safety cabinet for, among other things, making the safety cabinet easy to locate and indicating the nature of the contents stored in the safety cabinet, especially in situations where the safety cabinet is located in a room where there is smoke or low light.

### CROSS-REFERENCE TO RELATED APPLICATIONS

This patent application claims the benefit of priority to U.S. Provisional Patent Application No. 60/779,591, filed Mar. 6, 2006, and entitled “Safety Cabinet,” which is incorporated in its entirety herein by this reference.

### FIELD OF THE INVENTION

The present invention relates generally to a safety cabinet for flammable, combustible, or other hazardous materials.

### BACKGROUND OF THE INVENTION

A safety cabinet for storing flammable or explosive materials is known in the art. Such a safety cabinet located at a plant allows for the onsite storage of flammable material. The safety cabinet can be provided to insulate flammable material stored within it from the direct effects of an external fire to prevent the flammable material from adding to the deleterious effect of the original fire. Because of the nature of the materials stored in a safety cabinet and the risks they pose to personnel in the vicinity of the safety cabinet, it is desirable to alert those in the area of these risks. Often, either according to law or to an internal standard operating procedure, the safety cabinet is equipped with a locking mechanism, which provides an added safety feature by preventing inadvertent, improper usage of the flammable material and by allowing access to the flammable material to be restricted only to authorized personnel.

Nonetheless, these devices are still susceptible to accidental opening and damage to latching systems by work related activities near the safety cabinet. Furthermore, previous safety cabinets can be difficult to transport, for example, from one location to another within a facility.

### SUMMARY OF THE INVENTION

To provide improved security and control over access to the contents stored in a safety cabinet, the present invention provides a safety cabinet that includes a removable lock bar that can be locked in place across the access door or doors of the safety cabinet. When secured to the cabinet, the lock bar provides a means for preventing the inadvertent opening of the safety cabinet doors. A retaining arm projects from each side of the safety cabinet such that it is engageable with the lock bar adjacent its two ends. A lock bar support can project from each door of the safety cabinet such that it is engageable with the lock bar to provide further support thereof. Each end of the lock bar can include a lock hole that aligns with a mating lock hole in the respective retaining arm. A lock, such as a padlock, can be fitted through each pair of aligned holes to retentively secure the lock bar to the retaining arms such that the lock bar extends across the front of the safety cabinet. The retaining arms can be positioned such that the lock bar extends across each door of the safety cabinet and a handle for opening the doors. In some embodiments, the handle can be a paddle handle that is substantially flush with the outer surface of the door of the safety cabinet in which it is mounted. The handle can be operably arranged with a latch system for securing each door of the safety cabinet in a closed position. Once locked in place, the lock bar will prevent the cabinet doors from opening, providing a simple and efficient means to ensure the safety cabinet remains inaccessible to those without means to unlock the locks.

The lock bar can contain a plurality of notches extending inwardly from its bottom edge that correspond in location and number with notches extending inwardly from the top edges of the retaining arms and each lock bar support. When the lock bar is lowered onto the retaining arms and supports, the notches of the lock bar mate with the respective notches of the arms and the supports to mount the lock bar to the enclosure and to hold the lock bar in place in vertical alignment with the handle for opening the doors of the cabinet. In one embodiment, the lock bar can include a pair of flanges that extend outwardly from the front of the lock bar and are disposed at each end of the lock bar such that they are respectively in adjacent relationship with the distal end of the retaining arms when the lock bar is mounted thereto. Each flange includes a hole that aligns with a respective hole in the retaining arms when the lock bar is mounted to the retaining arms. A padlock can be placed through each pair of aligned holes in the retaining arms and the lock bar to lock the lock bar to the enclosure.

The lock bar presents a substantial physical barrier to the mechanism used to open the cabinet, thereby reducing the likelihood that the handle and latch system would be inadvertently operated. The lock bar also provides additional security against unauthorized access to the contents of the safety cabinet by covering the handle and latch and limiting such access to those who can open the locks that retain the lock bar to the retaining arms.

In one aspect of the present invention, the lock bar is a different color than the color of the doors of the safety cabinet. The contrasting colors enable an observer, even at a distance, to verify quickly and easily whether the safety cabinet is being maintained with the doors in a closed position. Furthermore, the placement of the lock bar locks can allow an observer to determine quickly and easily whether the lock bar has been locked to the retaining arms.

In another aspect of the present invention, the safety cabinet can include a pair of forklift pockets located in a base of the safety cabinet. The forklift pockets can be configured to accommodate, respectively, the two blades of a forklift, thereby making the safety cabinet easily transportable via a forklift.

In yet another aspect of the present invention, the safety cabinet can include a hazard indicator located on an external surface of the safety cabinet. The hazard indicated can include indicia to convey to personnel in the vicinity the nature of the hazard posed by the materials stored in the safety cabinet. The hazard indicator can be made, at least in part, of a reflective material, preferably a retroreflective material.

These and other features of the present invention will become apparent to one of ordinary skill in the art upon reading the detailed description, in conjunction with the accompanying drawings, provided herein.

### BRIEF DESCRIPTION OF THE DRAWINGS

FIG. 1 is a perspective view of an embodiment of a safety cabinet according to the present invention.

FIG. 2 is a front elevational view of the safety cabinet of FIG. 1.

FIG. 3 is a side elevational view of the safety cabinet of FIG. 1.

FIG. 4 is an enlarged detail view taken from FIG. 2.

FIG. 5 is a cross-sectional view taken along line V-V in FIG. 2.

FIG. 6 is an enlarged detail view taken from FIG. 3.

FIG. 7 is a front elevational view of a lock bar of the safety cabinet of FIG. 1.

FIG. 8 is a top plan view of the lock bar of FIG. 7.

FIG. 9 is an enlarged detail view of the lock bar taken from FIG. 7.

FIG. 10 is an enlarged detail view of the lock bar taken from FIG. 8.

FIG. 11 is an enlarged, fragmentary perspective view of the lock bar of FIG. 7 and a right retaining arm of the safety cabinet of FIG. 1.

FIG. 12 is a view similar to FIG. 11 wherein the lock bar of FIG. 7 is engaged with the right retaining arm and a lock extends through aligned holes in both to secure the lock bar to the right retaining arm.

FIG. 13 is a front elevational view of a base assembly of the safety cabinet of FIG. 1.

FIG. 14 is a side elevational view of the base assembly of FIG. 13.

FIG. 15 is a top plan view of the base assembly of FIG. 13.

FIG. 16 is a cross-sectional view taken along line XVI-XVI in FIG. 2.

FIG. 17 is an enlarged, fragmentary perspective view of the base assembly of FIG. 13.

FIG. 18 is a top plan view of the safety cabinet of FIG. 1 wherein a pair of doors of the safety cabinet are in an open position.

FIG. 19 is an enlarged detail view taken from FIG. 18.

FIG. 20 is a top plan view of the safety cabinet of FIG. 1 with a top portion of the outer shell removed for illustrative purposes.

FIG. 21 is a front elevational view of another embodiment of a safety cabinet according to the present invention.

FIG. 22 is a side elevational view of the safety cabinet of FIG. 21.

FIG. 23 is a front elevational view of an embodiment of a hazard indicator suitable for use with the present invention.

### DETAILED DESCRIPTION OF EMBODIMENTS OF THE INVENTION

In the following description, reference is sometimes made to the “left,” “right,” “top,” “bottom,” “front,” or other regions of the safety cabinet and its various components. It should be understood that these terms are used solely for convenient reference, inasmuch as the safety cabinet may be used omni-directionally.

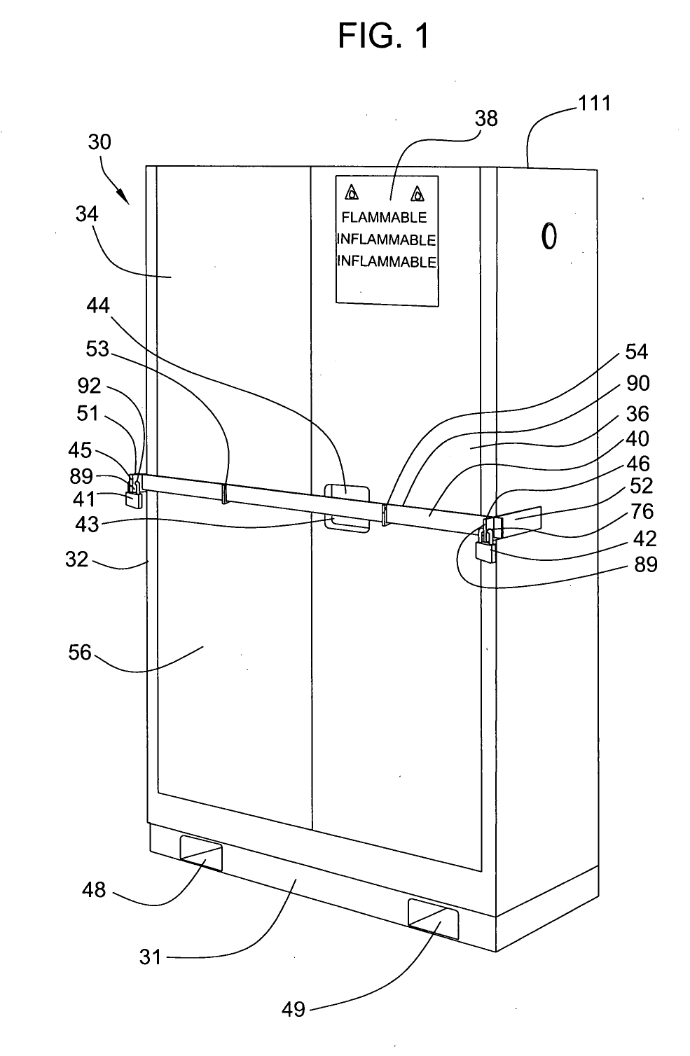

Turning now to the drawings, there is shown in FIG. 1 a safety cabinet 30 according to the present invention. The safety cabinet 30 can be used to store, for example, flammable liquids, flammable waste, corrosives, pesticides, or combustible waste. The safety cabinet can include a base assembly 31, an enclosure 32 resting upon the base assembly 31 and defining an access opening to an interior chamber, a left door 34 and a right door 36 hingedly mounted to the enclosure 32 to selectively seal the access opening, a hazard indicator 38 disposed on an exterior surface of the right door 36, a lock bar 40 for selectively preventing the doors 34, 36 from being opened, and a pair of padlocks 41, 42 for selectively locking the lock bar 40 to the enclosure 32.

The safety cabinet 30 can be provided with an indicator 38 that is disposed on an exterior surface thereof to readily identify the safety cabinet as a device for storing hazardous materials and to clearly indicate the nature of the contents stored therein. For example, the indicator 38 can identify the nature of the hazard posed by the material stored in the safety cabinet 30. The indicator 38 can include indicia configured to convey information to an observer thereof. The indicia can be a graphical symbol and/or writing to convey information concerning the contents stored in the safety cabinet 30. For example, the indicator 38 can include writings such as “Flammable” or “Danger” and a graphical symbol depicting a flame. It should be appreciated that the indicator 38 can include writings in any language and convey any message through a selected combination of letters and/or symbols.

In the embodiment of FIG. 1, the indicator 38 is disposed on the right door 36 adjacent a top end 111. In other embodiments, a plurality of multiple indicators 35 can be located at various positions on the safety cabinet 30.

In some embodiments, the indicator 38 can include indicia formed, at least in part, from a reflective material so as to be particularly visible when struck by light such as from a flashlight, for example, in low-level lighting conditions. In yet other embodiments, the indicator 38 can include, at least in part, a retroreflective material such that at least a portion of incident light hitting the retroreflective material is redirected toward its originating source. For example, the indicator 38 can include a suitable reflective material such as those commercially available from 3M of St. Paul, Minn., including the reflective sheeting marketed as Scotchlite™ reflective sheeting, Series 510-10, for example. In other embodiments, any other suitable retroreflective material can be used. In yet other embodiments, a reflective ink or paint can be applied directly to the exterior surface of the safety cabinet to form the indicator 38 using any suitable technique, including silk screening, for example.

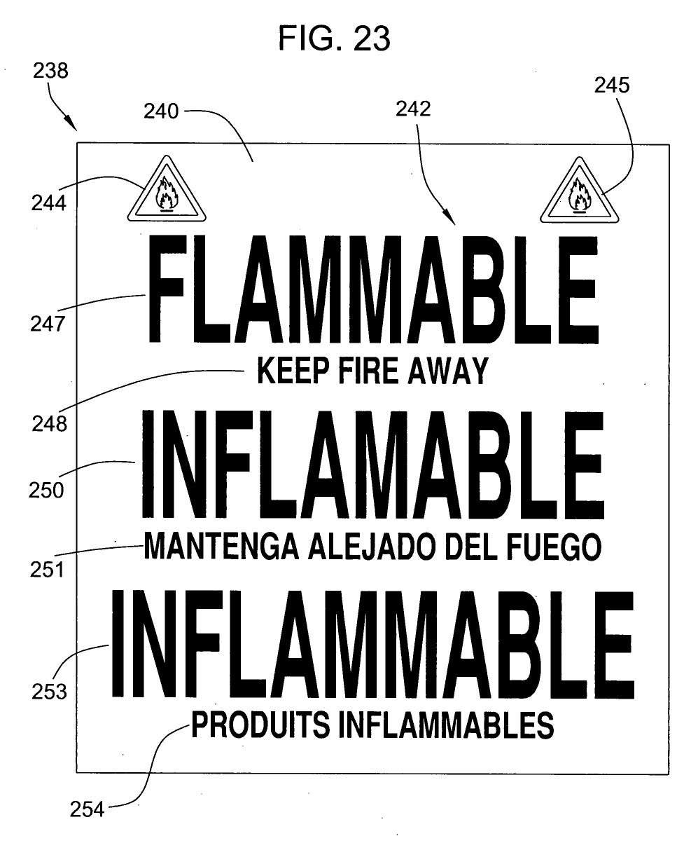

Referring to FIG. 23, another embodiment of an indicator 238 is shown. The indicator 238 can be in the form of a label 240 that is secured to an external surface of the safety cabinet via its adhesive-coated back surface comprising a pressure-sensitive adhesive. The indicator 238 includes indicia 242 including a pair of graphical symbols 244, 245 and a plurality of written messages 247, 248, 250, 251, 253, 254. The graphical symbols 244, 245 each include a triangle with a flame inside the triangle. In other embodiments, the indicator can include a plurality of symbols that are different from each other. The messages 247, 248, 250, 251, 253, 254 are in different languages, namely, English, Spanish, and French. In other embodiments, a single message can be used. In yet other embodiments, messages in different languages can be included.

The indicia 242 can be formed from a material that is reflective, and even more preferably from a material that is retroreflective. In this embodiment, the entire indicator label 240 comprises a retroreflective material that has a coefficient of retroreflection, as measured by ASTM E810, that allows the indicator 238 to retain its reflectivity when viewed at a wide entrance angle. For example, the indicator 238 can have a coefficient of retroreflection of at least about 35 candelas/footcandle/square foot when measured using a 2° observation angle and a −4° entrance angle, where the observation angle is an angle between the line formed by a light beam striking the reflective surface (the illumination axis) and the light formed by its reflective beam (the observation axis), and the entrance angle is the angle formed by the illumination axis and a line perpendicular to the surface at the same point (the retroreflector axis). Preferably, the indicator 238 has a coefficient of retroreflection when the indicator is totally wet of at least 90% of the value of the coefficient of retroreflection when the indicator 238 is dry.

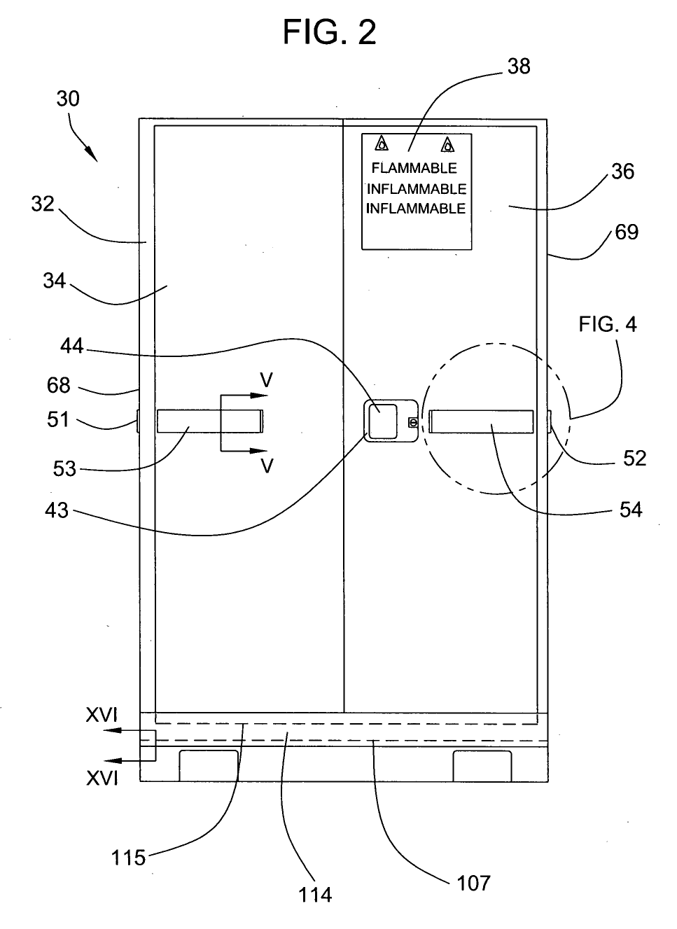

Referring to FIGS. 1 and 2, the safety cabinet 30 can include a latch system 43 for selectively retaining the doors 34, 36 in a closed position to cover the access opening of the enclosure 32. A paddle handle 44 can be mounted to one of the doors 36 and operably arranged with the latching system to disengage the latching system to allow the doors 34, 36 to move from the closed position to an open position. The latch system can comprise a three-point latch with one point latching the doors 34, 36 together and the other two points latching the door 36 to the enclosure 32. The paddle handle 44 and the latching system 43 of the safety cabinet 30 can be similar, for example, to the paddle handle and latching system as shown and described in U.S. Pat. No. 6,729,701, which is incorporated herein by reference in its entirety.

The lock bar 40 is securable to the enclosure 32 such that the lock bar 40 prevents the paddle handle 44 from moving to actuate the latch system and prevents the doors 34, 36 from moving from the closed position. The padlocks 41, 42 can be disposed at each end 45, 46 of the lock bar to lockingly retain the lock bar 40 to the enclosure 32. The base assembly 31 includes a pair of forklift pockets 48, 49 that are disposed in spaced relationship to each other and configured to accommodate a respective blade of a forklift fork to allow the use of a forklift for transporting the safety cabinet from one location to another. The safety cabinet 30 of the present invention can be similar in other respects to the safety cabinet as shown and described in U.S. Pat. No. 6,729,701.

Referring to FIG. 2, the latching system 43 can automatically latch the cabinet doors 34, 36 in the closed position. To open the doors 34, 36, the latching system may be released by operation of the paddle handle 44. In the illustrative embodiment, the latching system is disposed within the right cabinet door 36 and engages the enclosure 32 and the left door 34 to automatically latch both doors 34, 36 closed. In other embodiments, the paddle handle and the latching system can be disposed within the left cabinet door 34. In yet other embodiments, the access opening of the enclosure can be selectively covered by a single door.

Referring to FIG. 2, a pair of retaining arms 51, 52 and a pair of lock bar supports 53, 54 can be provided to support the lock bar 40 and to retain the lock bar 40 to the enclosure 32. As shown in FIG. 1, the lock bar 40 is mounted to the retaining arms 51, 52 and extends across the front 56 of the safety cabinet 30 between the left retaining arm 51 and the right retaining arm 52 so that the cabinet doors 34, 36 may not be opened while the lock bar 40 is secured in place.

Referring to FIG. 2, the retaining arms 51, 52, the lock bar supports 53, 54, and the paddle handle 44 of the latching system are in vertical alignment with each other. This allows the lock bar 40, when put in place on the safety cabinet 30, to rest on the retaining arms 51, 52 and the lock bar supports 53, 54 while also covering the paddle handle 44, as shown in FIG. 1, to prevent the handle 44 from operating. When secured in place on the cabinet 30, the lock bar 40 protects the paddle handle 44 from damage and prevents the paddle handle from being operated to avoid the accidental or unauthorized opening of the safety cabinet.

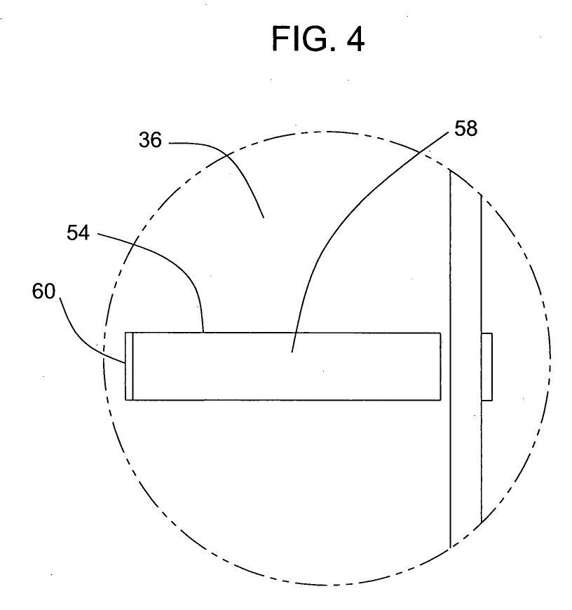

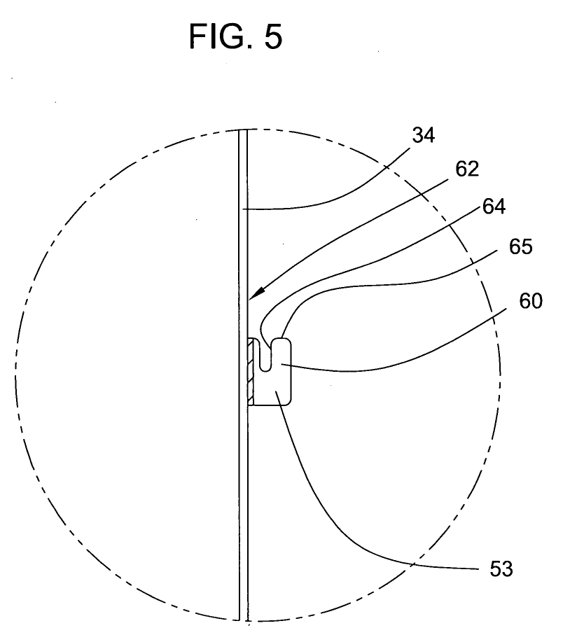

Referring to FIG. 2, the left lock bar support 53 is attached to the left cabinet door 34, and the right lock bar support 54 is attached to the right cabinet door 36. The lock bar supports 53, 54 are similar to each other, and, thus, the description of one is applicable to the other, as well. Referring to FIG. 4, each lock bar support 54 includes a plate 58 and a projecting support portion 60. The plate 58 is connected to the door 36 to which the lock bar support 54 is mounted, such as by welding, for example. Referring to FIG. 5, the support portion 60 extends outwardly from an outer surface 62 of the door 34. The support portion 60 includes a notch 64 that extends a predetermined distance downwardly from an upper edge 65 of the support portion. Preferably, the notch 64 extends to a point proximate the vertical midpoint of the support portion 60. The notch 64 of the lock bar support 53 is configured to matingly engage with a corresponding notch in the lock bar.

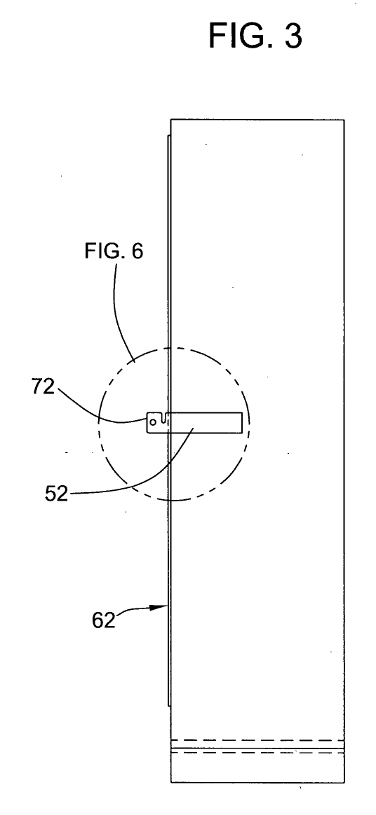

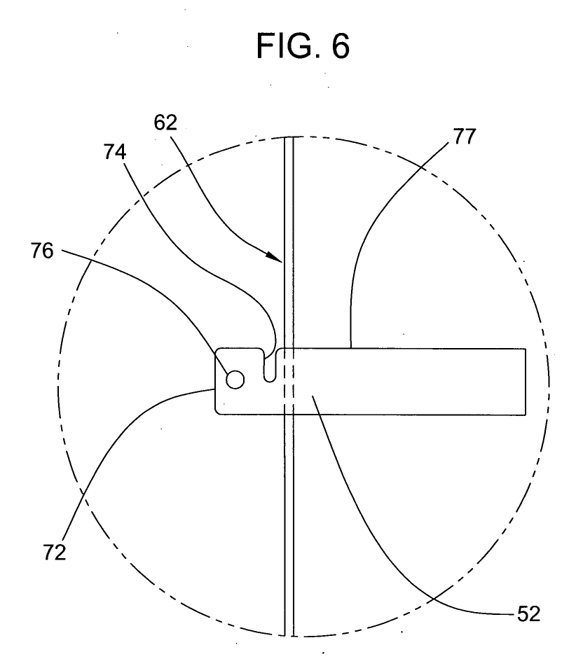

Referring to FIG. 2, the left retaining arm 51 is similarly attached to the left side 68 of the enclosure 32, and the right retaining arm 52 is attached to the right side 69 of the enclosure 32. The retaining arms 51, 52 are similar to each other, and, thus, the description of one retaining arm is applicable to the other retaining arm, as well. Referring to FIGS. 3 and 6, a distal end 72 of the retaining arm 52 extends a predetermined distance beyond the outer surfaces 62 of the doors. Referring to FIG. 6, the distal end 72 includes a mounting notch 74 and a lock hole 76. The mounting notch 74 is similar in size and configuration to the notch of the lock bar support. The mounting notch 74 extends downwardly a predetermined distance from an upper edge 77 of the retaining arm 52. Preferably, the mounting notch 74 extends to a point proximate the vertical midpoint of the retaining arm. The mounting notch 74 is configured to matingly engage a corresponding notch in the lock bar.

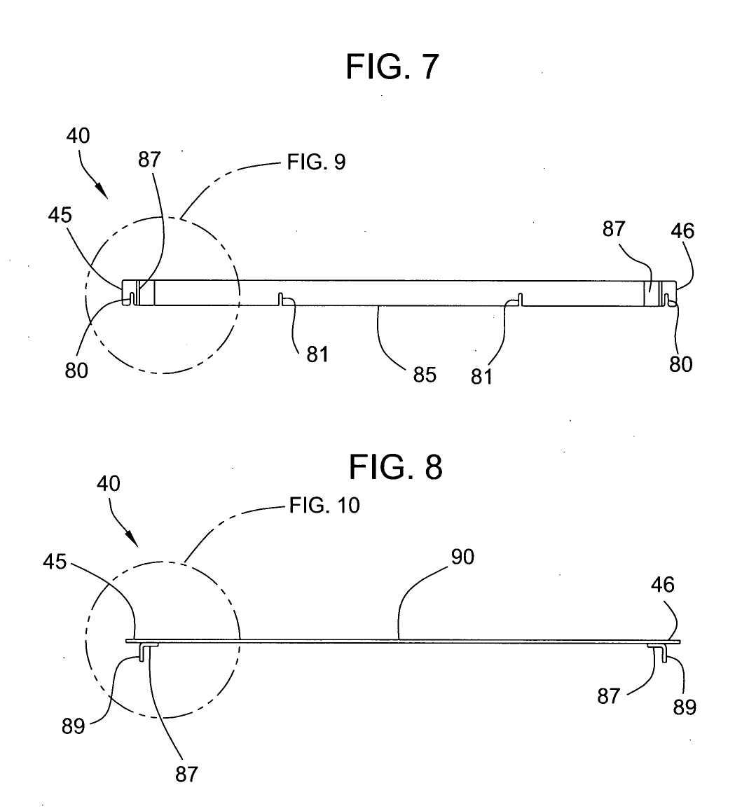

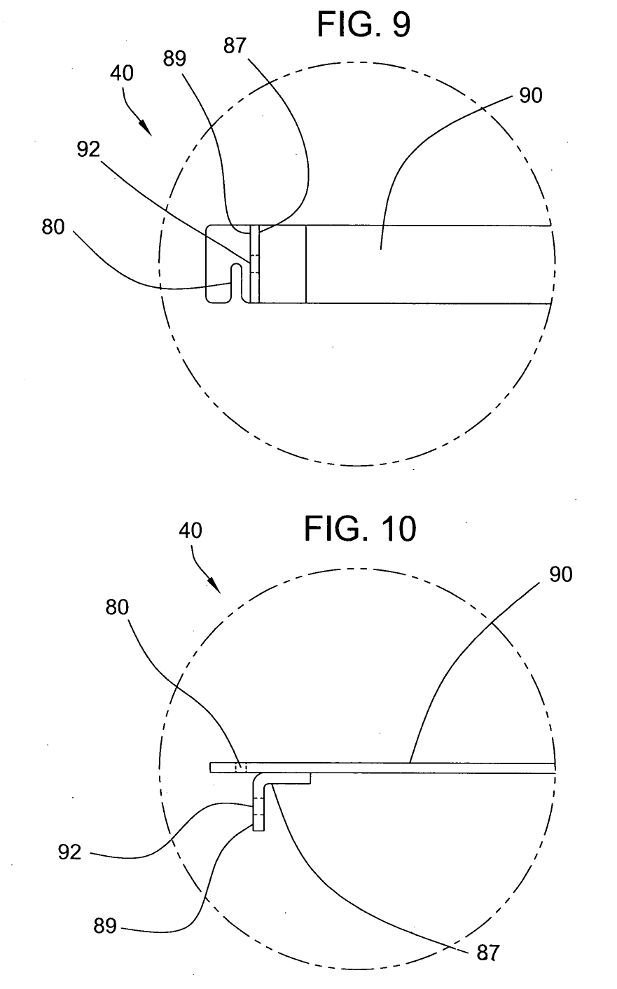

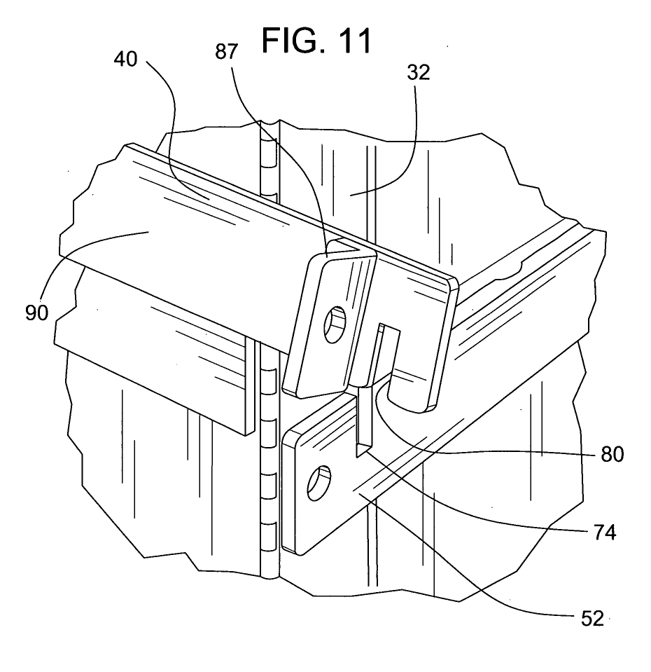

Referring to FIGS. 7-10, the lock bar 40 is shown. Referring to FIG. 7, the lock bar 40 includes a pair of mounting notches 80 that are configured to retentively mate with the respective notches in the retaining arms, and a pair of support notches 81 that are configured to retentively mate with the respective notches in the lock bar supports. The notches 80, 81 of the lock bar 40 extend upwardly from a bottom edge 85 thereof to a predetermined point that is preferably proximate the vertical midpoint of the lock bar 40. Each notch 80, 81 of the lock bar is disposed in spaced relationship with the other notches of the lock bar such that the lock bar 40 can be mounted to the retaining arms and the lock bar supports with the notches of the lock bar and the retaining arms and the lock bar supports respectively interengaging each other. The lock bar 40 can also include a pair of flanges 87 respectively disposed at the end 45, 46 of the lock bar. Referring to FIG. 8, each flange is L-shaped and is disposed such that a portion 89 thereof, comprising a lock lug, extends from a substantially planar body 90 of the lock bar 40. The lock bar 40 is preferably made from metal, such as, steel, for example.

Referring to FIGS. 7, 9, and 10, each flange 87 is located between the interior support notches 81 and the exterior retaining notches 80 in the lock bar. Each flange 87 is respectively disposed adjacent one of the retaining notches 80. Each flange 87 has a lock hole 92 that is disposed in the padlock lug 89 of the flange, which extends from the body 90 of the lock bar.

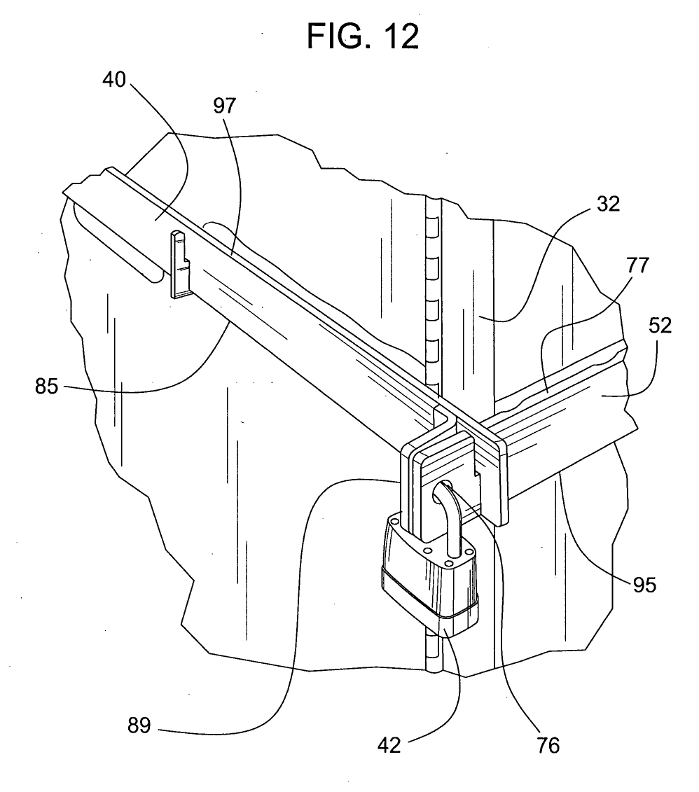

Referring to FIGS. 11 and 12, the retaining notches 80 of the lock bar 40 are positioned on the bar 40 so that when the lock bar 40 is mounted to the enclosure 32, the exterior notches 80 of the lock bar 40 will engage the notches 74 of the retaining arms. Referring to FIG. 11, to mount the lock bar 40 to the retaining arms 52, the lock bar 40 is placed vertically above the retaining arms such that the notches 80 of the lock bar are open toward the notches 74 of the retaining arms. The lock lugs 87 of the lock bar are disposed such that they are positioned between the retaining arms 52 when the notches 80 of the lock bar are aligned with the notches 74 of the retaining arms and the lock bar supports. With the notches aligned, the lock bar 40 can be lowered onto the retaining arms and the lock bar supports to retain the lock bar 40 to the enclosure 32. The body 90 of the lock bar 40 is disposed in substantially perpendicular relationship to the retaining arms 51, 52 and the lock bar supports 53, 54 such that the lock bar 40 is disposed within the notches of the retaining arms 51, 52 and the lock bar supports 53, 54 and vice versa, as shown in FIG. 1. The interengagement of the notches prevents the lock bar 40 from moving in any direction other than vertically upward. Referring to FIG. 12, the lock bar 40 can be mounted to the enclosure 32 such that the top and bottom edges 77, 95 of the retaining arms 52 are respectively aligned with the top and bottom edges 97, 85 of the lock bar 40 when the lock bar 40 is mounted thereto.

Referring to FIG. 1, when the lock bar 40 is in place on the safety cabinet 30, the interaction of the notches of the lock bar 40 and the notches of the retaining arms 51, 52 and the lock bar supports 53, 54 allows the lock bar 40 only to be removed by lifting it up and away from the notches it is resting in. As shown in FIGS. 1 and 12, the lock bar 40 prevents the cabinet doors 34, 36 from being opened when it is mounted to the retaining arms 51, 52.

Referring to FIGS. 1 and 12, the holes 76 in the retaining arms 51, 52 are aligned with the holes 92 in the lock lugs 89 of the lock bar 40 when the lock bar 40 is mounted to the retaining arms 51, 52. The alignment of the holes 76, 92 permits the locks 41, 42 to be respectively placed through the pairs of aligned holes to thereby lock the lock bar 40 to the retaining arms 51, 52. The locks 41, 42 can secure the lock bar 40 to the enclosure 32 at both ends 45, 46 of the lock bar, as seen in FIG. 1. Each lock 41, 42 prevents the lock bar 40 from being moved vertically upward with respect to the retaining arms 51, 52 to thereby secure the lock bar to the retaining arms. When the lock bar 40 is so locked in place, it is not possible to open the cabinet 30 without first removing the locks 41, 42 and then removing the lock bar 40. This permits an individual with control over the locks 41, 42 to strictly control access to the safety cabinet 30. Any suitable lock can be used, such as, a No. 5 Master Lock padlock commercially available from the Master Lock Company of Oak Creek, Wis., for example. Other suitable locks include combination locks or a plurality of keyed locks with all the locks being operable by a single key.

Referring to FIG. 1, the lock bar 40 can be a different color than the rest of the safety cabinet 30. For example, the lock bar 40 can be the color red, whereas the doors 34, 36 and the enclosure 32 of the safety cabinet can be the color yellow. The contrasting colors of the lock bar 40 and the rest of the safety cabinet can allow for ready visual verification that the lock bar 40 is in place on the retaining arms. Furthermore, the placement of the lock holes at each end 45, 46 of the lock bar 40 allows for ready visual verification that the locks 41, 42 are in place through the aligned holes to lockingly retain the lock bar 40 to the retaining arms 51, 52. Such an arrangement allows a manager of a facility, for example, to readily verify that any hazardous material stored in the safety cabinet is securely stowed and accessible only to authorized personnel.

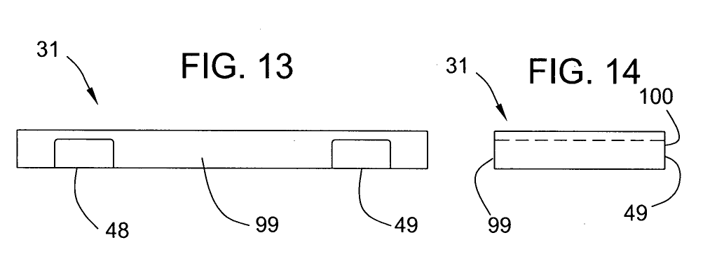

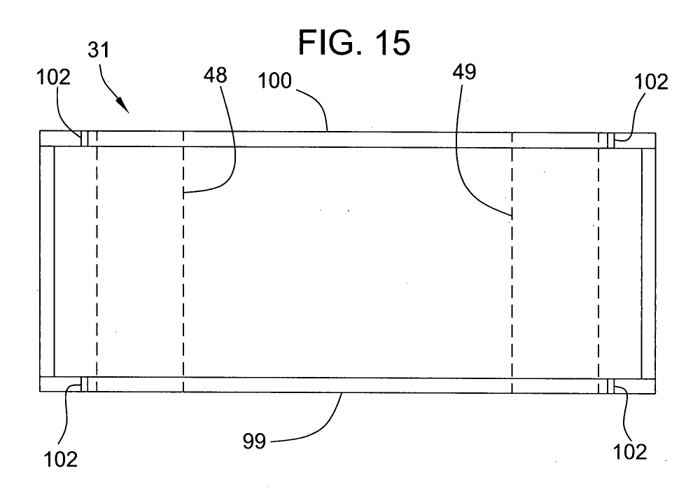

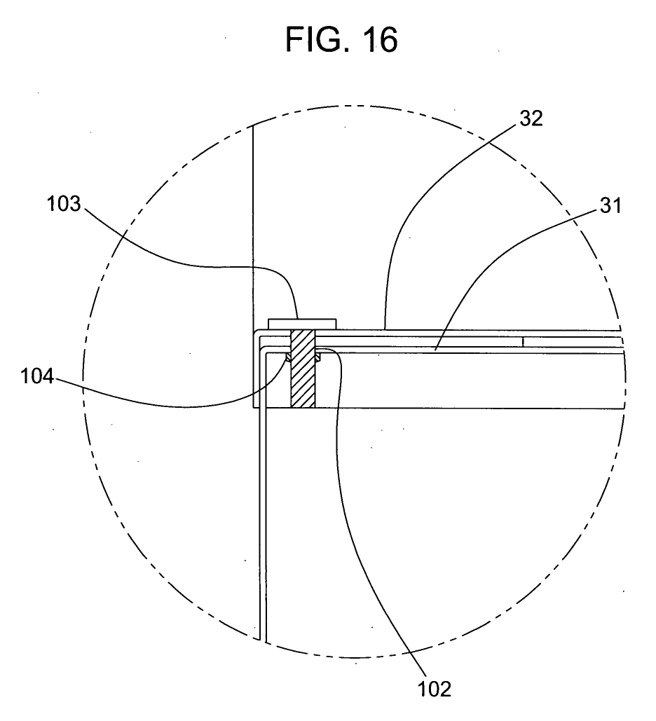

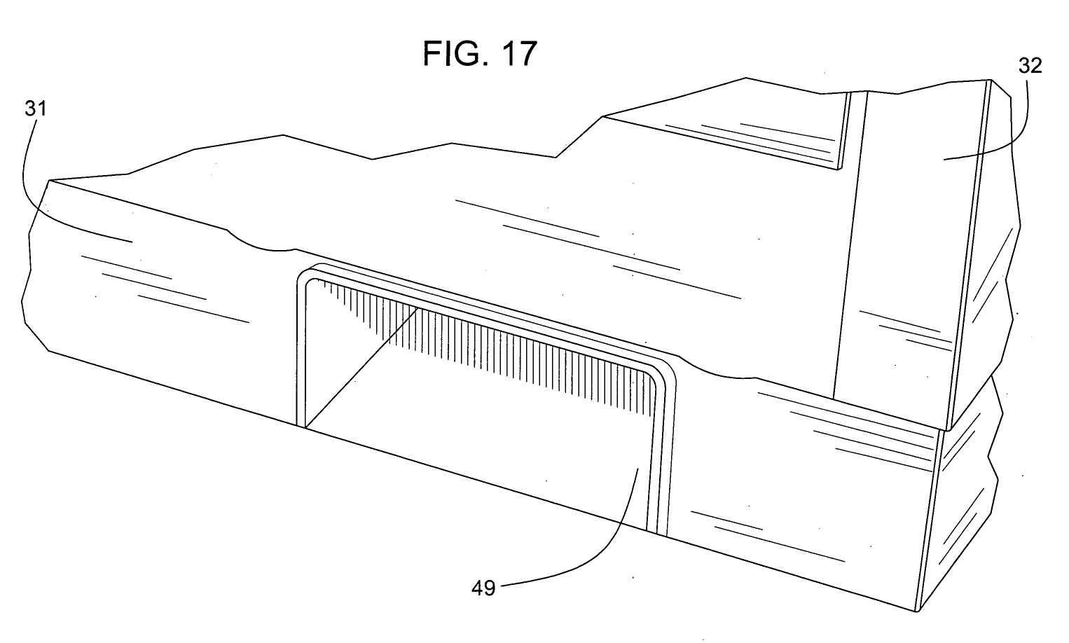

Referring to FIGS. 13-17, the base 31 is shown. The base 31 supports the enclosure 32, which can be mounted thereto by a plurality of fasteners, for example. The base 31 includes two rectangular forklift pockets 48, 49, which are spaced and sized such that they can accommodate the two blades of a forklift fork. The forklift pockets 48, 49 pass through the base 31 of the safety cabinet from the front 99 to the rear 100 thereof, as shown in FIGS. 14 and 15, and are parallel to one another. When the fork of a forklift engages the safety cabinet by extending into the forklift pockets 48, 49, the forklift may lift and maneuver the safety cabinet to a desired location. Referring to FIGS. 15 and 16, the base 31 can include a plurality of mounting holes 102 configured to accept a fastener to retain the enclosure 32 to the base 31. In FIG. 16, a suitable fastener arrangement is shown. A weld stud 103 can be secured with a flange nut 104 having a clinch form center lock to secure the enclosure 32 to the base 31.

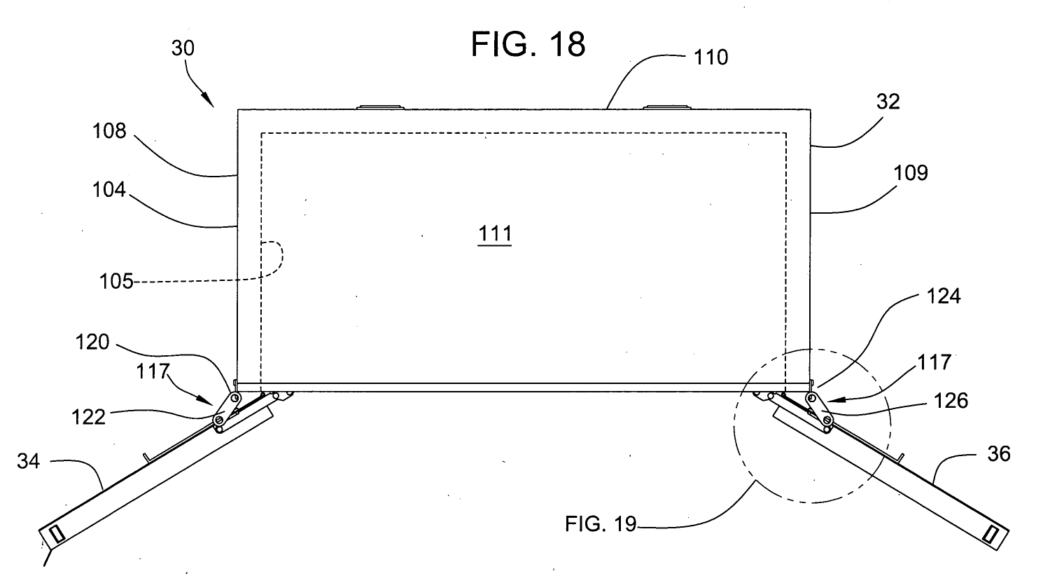

Referring to FIG. 18, the enclosure 32 can include an outer shell 104 and an inner shell 105. The outer shell 104 includes an outer bottom wall 107 (FIG. 2), an outer left side wall 108, an outer right side wall 109, an outer rear wall 110, and an outer top wall 111. The enclosure 32 includes the inner shell 105 to provide a double-walled construction, wherein each said outer wall of the outer shell 104 has a corresponding inner wall of the inner shell 105, with said inner and outer walls separated by a predetermined distance to define an insulative air space. The inner shell 105 defines the interior chamber that is accessible through the access opening selectively sealed by the doors. In some embodiments a shelf, or a plurality of shelves, can be disposed in the interior chamber to provide various storage options.

Referring to FIG. 2, a sealed sump area 114 can be provided between the inner bottom surface 115 and the outer bottom surface 107 of the enclosure 32. The sump area 114 is liquid tight and is provided to collect any liquid that may leak from a vessel stored in the cabinet 30. The enclosure 32 of the safety cabinet 30 can be similar in other respects to the enclosure as shown and described in U.S. Pat. No. 6,729,701, for example.

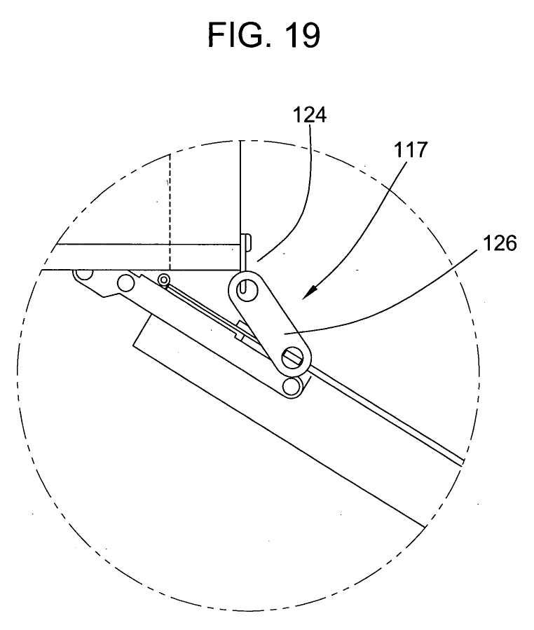

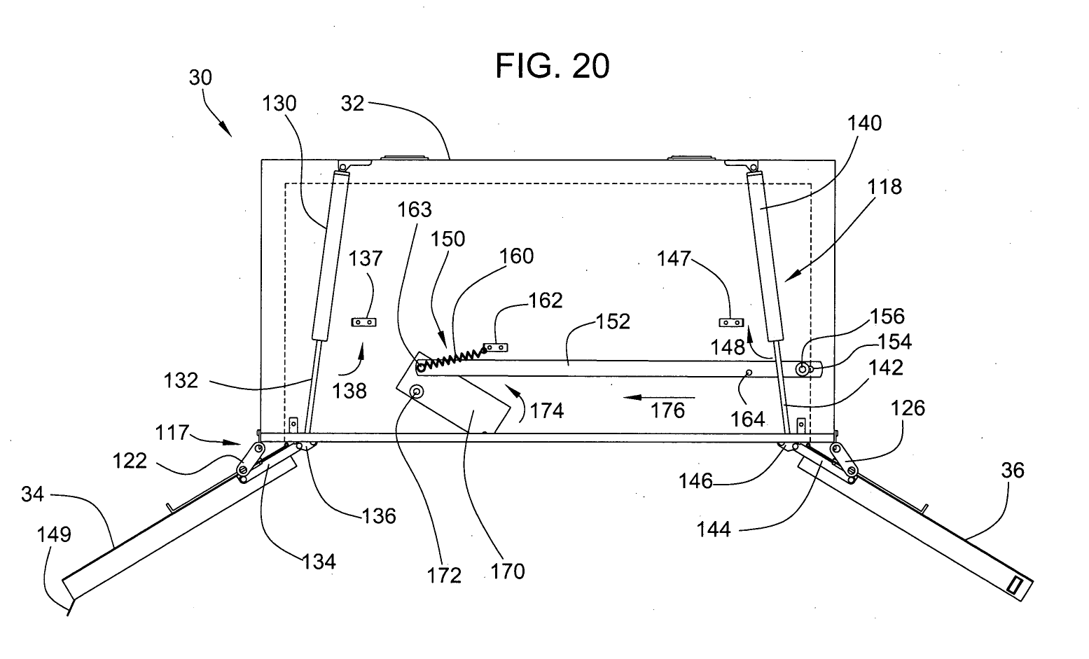

Referring to FIGS. 18 and 19, the safety cabinet 30 can include a retaining system 117 for retaining the doors 34, 36 in an open position, as shown in FIG. 18. Referring to FIG. 20, the safety cabinet 30 can include a closure system 118 to automatically close the doors 34, 36 in the event of a fire and to assist in moving the doors from an open position to a closed position under normal conditions. The retaining system 117 and the closure system 118 can be respectively similar in function and in construction to the retaining system and closure system as shown and described in U.S. Pat. No. 6,729,701.

Referring to FIG. 18, in use, the left and right doors 34, 36 can be manually moved by a user between the closed position, as shown in FIG. 2, and the open position shown in FIG. 18. The loading and unloading of the safety cabinet 30 are facilitated if the left and right doors 34, 36 remain in the open position. The retaining system 117 is provided to retain the left and right doors 34, 36 in the open position, as shown in FIG. 18.

In a preferred embodiment, the retaining system 117 includes a first retaining element 120 with a first fusible link 122. The first retaining element 120 has a detent feature that acts to retain the left door 34 in the open position. The first fusible link 122 is mounted to the left door 34 and the enclosure 32. The fusible link 122 is constructed such that the fusible link 122 fuses, i.e., melts, when the ambient temperature is above a selected level to thereby detach the link from the enclosure 32 to allow the closure system to move the door 34 to the closed position. The retaining system 117 includes a second retaining element 124 with a second fusible link 126. The second retaining element 124 is similar to the first retaining element 122 and is used to hold the right door 36 in the open position. The second fusible link 126 is similar to the first fusible link 120 and similarly provides means to release the right door 36 in the event of a rise in ambient temperature. The second link 126 is mounted to the right door 36 and the enclosure 32. In one embodiment of the fusible link, the link is constructed such that it will fuse when the ambient temperature is 165° F. In embodiments of the safety cabinet including a single door, the retaining system can include a single retaining element.

In use, the left and right doors 34, 36 can be moved from the closed position, which is shown in FIG. 2, to the open position, as shown in FIG. 18. The retaining system 117 acts to retain the left and right doors 34, 36 in the open position. The left and right doors 34, 36 can be moved to the closed position from the open position either manually by overcoming the retaining hold of the retaining elements 120, 124 or automatically by providing a means to automatically close the doors 34, 36 in the event that the fusible links 122, 126 melt.

Referring to FIG. 20, the closure system 118 is provided to automatically close the doors 34, 36. In the illustrative embodiment, a first air cylinder 130, which includes a moveable piston 132, is rotatably mounted to the enclosure 32. The first air cylinder 130 is disposed between the outer and inner top walls of the enclosure 32. A left linkage 134 is mounted to the left door 34 and rotatably mounted to a distal end 136 of the piston 132. The piston 132 of the first air cylinder 130 is configured to bias the left door 34 to the closed position. A first stop 137 is provided to limit the range over which the first air cylinder 130 can rotate in a closing direction 138. In a similar fashion as the first air cylinder 130, a second air cylinder 140, which includes a moveable piston 142, is rotatably mounted to the enclosure 32. A right linkage 144 is mounted to the right door 36 and rotatably mounted to a distal end 146 of the piston 142 of the second air cylinder 140. The piston 142 of the second air cylinder 140 is configured to bias the right door 36 to the closed position. A second stop 147 is provided to limit the range over which the second air cylinder 140 can rotate in a closing direction 148. It will be understood that in other embodiments, other biasing elements can be used in place of the first and second air cylinders 130, 140, such as, springs, for example.

In the event of fire, for instance, the closure system 118 cooperates with the fusible links 122, 126 to automatically close the doors 34, 36. When the ambient temperature exceeds the predetermined level, the first fusible link 122 and the second fusible link 126 melt. The first and second air cylinders 130, 140 can act to move the left and right doors 34, 36, respectively, to the closed position. Under normal operating conditions, the closure system 118 can provide an assist feature during the manual closing of the doors 34, 36 by urging the doors 34, 36 to the closed position once the retaining system 117 is overcome.

Referring to FIG. 20, to further seal the interior chamber of the enclosure 32 from the outside environment when the doors 34, 36 are in the closed position, the left door 34 can include a baffle 149 extending along substantially the entire height of the door 34 and projecting at an oblique angle therefrom. Once the left door 34 is closed, the right door 36 may then be closed to engage the baffle 149. Thus, during the closing of the left and right doors 34, 36, it is advantageous that the doors 34, 36 close in sequence wherein the left door 34 reaches the closed position prior to the right door 36 doing so. It is also advantageous that this sequence be maintained regardless of the sequence in which fusible links 122, 126 melt.

The illustrative embodiment of the closure system 118 of the safety cabinet 30 includes a timing mechanism 150 mounted to the enclosure 32 to control the sequence of the closing of the doors 34, 36 such that the left door 34 is placed in the closed position before the right door 36 is. The timing mechanism 150 is constructed in a fashion similar to the timing mechanism disclosed in U.S. Pat. No. 5,992,098, which is incorporated herein by reference in its entirety. The timing mechanism 150 includes a timing slide bracket 152 that is disposed between the outer and inner top walls of the enclosure 32. The timing slide bracket 152 includes a slot 154 and is slidably mounted upon a slide pivot pin 156, which is disposed in the slot 154. The timing slide bracket 152 is moveable over a range of travel that is defined by the dimensions of the slot 154.

A slide bracket spring 160 is attached to a spring anchor 162 and to an end 163 of the timing slide bracket 152 to bias the timing slide bracket 152 to a normal position, as shown in FIG. 20, with the slide pivot pin 156 positioned at the leftmost extreme of the slot 154. When the doors 34, 36 are in the open position, the timing slide bracket 152 is positioned in the normal position. A stop 164 is mounted to the timing slide bracket 152 and is disposed such that the stop 164 will contact the right linkage 144 as the right door 36 closes. In this manner, during the closing of the right door 36, the stop 164 engages the right linkage 144 such that the stop 164 selectively prevents the right door 36 from moving to the closed position.

An actuating plate 170 is pivotally mounted to the inner top wall of the enclosure 32 by a plate pivot pin 172 and is pivotally mounted to the timing slide bracket 152. When the actuating plate 170 is rotated in a closing direction 174, the timing slide bracket 152 is moved in a disengaging direction 176. The right door 36 will remain partially open until the timing slide bracket 152 moves leftward a sufficient distance to position the stop 164 out of the path of the right linkage 144.

In operation, the doors 34, 36 are closed either manually or automatically by moving the doors 34, 36 from the open position to the closed position. The right door 36 can rotate toward the closed position until the right linkage 144 contacts the stop 164, thereby preventing further movement of the right door 36. The left door 34 can freely rotate from the open position toward the closed position until it engages the actuator plate 170. Continued movement of the left door 34 pivots the actuator plate 170 about the pin 172 in the closing direction 174, thereby drawing the timing slide bracket 152 in the disengaging direction 176 to move the stop 164 out of the path of the right linkage 144. The left door 34 is moved to the closed position. The right door 36 completes its movement to the closed position. The timing mechanism 150 allows the left door 34, which includes the baffle 149, to move to the closed position before the right door 36 does. Such an arrangement allows the left and right doors 34, 36 to cooperate to provide a protective seal.

In embodiments of the safety cabinet including a single door, the closure system can include a single air cylinder, linkage, and stop. Such a closure system can also omit the timing mechanism 150.

Referring to FIG. 2, once closed, it is preferred that the doors 34, 36 remain closed for maximum safety. To provide automatic latching capability, the latch system 43 is provided. The latch system 43 is disposed in the right door 36. In the illustrative embodiment, the safety cabinet 30 includes both the left and right doors 34, 36. The latch system 43 can operate to automatically latch both of the doors 34, 36 in the closed position. The latch system 43 is particularly useful in conjunction with the closure system when the safety cabinet includes left and right doors 34, 36. The timing mechanism of the closure system ensures that the left door 34 is in the closed position prior to the right door 36 being in the closed position. With that sequence in place, the latch system 43 can automatically engage the left door 34 and the enclosure 32 without operation if the paddle handle 44 to latch the right door 36 to the left door 34 and to the enclosure 32, thereby selectively retaining both the left door 34 and the right door 36 in the closed position.

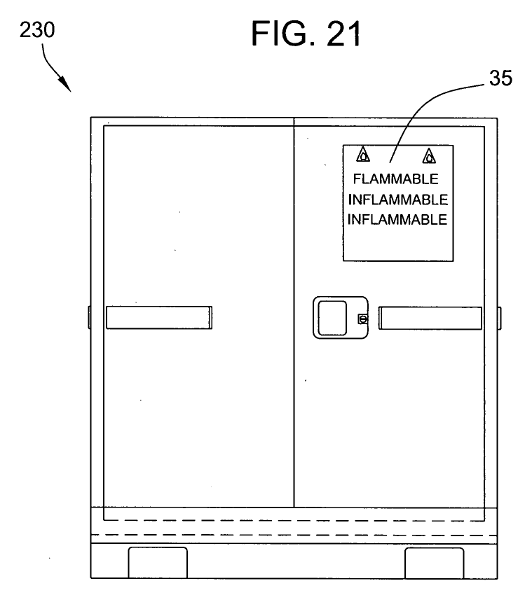

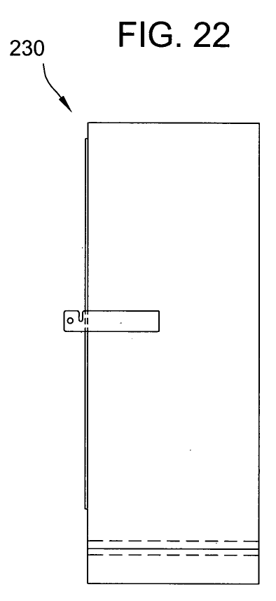

Referring to FIGS. 21 and 22, another embodiment of a safety cabinet 230 according to the present invention is shown. The safety cabinet of FIG. 21 is similar to the safety cabinet of FIG. 1 except that the safety cabinet of FIG. 21 has a smaller capacity than that of the safety cabinet of FIG. 1. The safety cabinet of FIG. 1 has a 45 gallon capacity, whereas the safety cabinet of FIG. 21 has a 30 gallon capacity. The safety cabinet of FIG. 21 is similar in other respects to the safety cabinet of FIG. 1. The lock bar 40 of the safety cabinet 30 of FIG. 1 can be used with the safety cabinet 230 of FIG. 21.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A safety cabinet comprising:
an enclosure defining an opening, the enclosure having a front, a back, a top, a bottom, a first side, and a second side;
a door rotatably attached to the enclosure, the door movable between an open position and a closed position, the door configured to cover at least a portion of the opening of the enclosure when in the closed position, the door including an outside surface and an inside surface;
a first retaining arm attached to the first side of the enclosure so that a portion extends past the front of the enclosure, wherein the protruding portion defines a notch and a hole;
a second retaining arm attached to the second side of the enclosure so that a portion extends past the front of the enclosure, wherein the protruding portion defines a notch and a hole;
a first lock;
a second lock;
a lock bar support attached to the outside surface of the door, the lock bar having an extension that extends from the surface of the door, wherein this extension defines a notch; and
a removable lock bar that can be placed transversely across the front of the safety cabinet so that it rests on the retaining arms and lock bar support, the lock bar including:
a rigid body that has a top, a bottom, a front, a back, a first end, a second end, the bar defining a first exterior notch, a second exterior notch, and an interior notch, the bar being configured so that when the lock bar is put on the safety cabinet the first exterior notch will engage the notch of the first retaining arm, the second exterior notch will engage the notch of the second retaining arm, and the interior notch will engage the notch of the lock bar support,
a first lug which projects from the front of the body, the first lug defining a hole therethrough,
a second lug which projects from the front of the body, the second lug defining a hole therethrough,
wherein, while in retentive engagement with the first and second retaining arms, the lock bar will prevent the door from being moved from the closed position,
wherein, while in retentive engagement with the first and second retaining arms, the hole in the first lug of the lock bar aligns with the hole of the first retaining arm so that the first lock is extendible through the aligned holes and the hole in the second lug aligns with the hole of the second retaining arm so that the second lock is extendible through the aligned holes.

2. The safety cabinet as described in claim 1, further comprising:
a latching system to automatically latch the cabinet door in the closed position;
a handle for operating the latching system; and
wherein when the lock bar is in place on the safety cabinet it at least partially covers the handle of the latching system.

3. The safety cabinet as described in claim 1, wherein the safety cabinet includes a base upon which the enclosure is mounted, the base including a pair of forklift pockets which pass through the base and are able to accommodate the two blades of the fork of a forklift.

4. The safety cabinet as described in claim 1, wherein the safety cabinet comprises a double walled construction.

5. The safety cabinet as described in claim 4 wherein the door comprises an inner panel and an outer panel that define an insulative air space.

6. The safety cabinet as described in claim 5 wherein the enclosure includes a floor portion defining a sump area for retaining fluid.

7. The safety cabinet as described in claim 1 further comprising:
a closure system operably arranged with the door to bias the door to a closed position.

8. The safety cabinet as described in claim 7, further comprising:
a retaining system to selectively retain the door in the open position.

9. The safety cabinet as described in claim 8, wherein the retaining system includes a fusible link, the fusible link mounted to the door and the enclosure, the fusible link being constructed such that the fusible link will fuse when the ambient temperature is above a selected level to thereby detach the link from the enclosure to allow the closure system to the move the door to a closed position.

10. The safety cabinet as described in claim 1 further comprising:
a second door rotatably attached to the enclosure, the second door being movable between an open position and a closed position, the doors, when in the closed position, cooperating with each other to cover the opening of the enclosure.

11. The safety cabinet as described in claim 10 further comprising:
a second lock bar support mounted to the second door that is similarly configured to the first lock bar support such that it includes a portion protruding from the door that defines a notch; and
wherein the lock bar defines a second interior notch that interacts with the notch of the second lock bar support in the same manner and function as the first interior notch interacts with the first lock bar support.

12. The safety cabinet of claim 11 wherein the first door includes a baffle.

13. The safety cabinet as described in claim 12, further comprising:
a latching system to automatically latch both the cabinet doors in the closed position;
a handle for operating the latching system located on the first cabinet door; and
wherein when the lock bar is in place on the safety cabinet it at least partially covers the handle of the latching system.

14. The safety cabinet as described in claim 13, the safety cabinet further comprising:
a closure system operably arranged with the doors to bias the doors to the closed position, the closure system including a timing mechanism mounted to the enclosure to control the sequence of the closing of the doors such that the first door is place in the closed position before the second door.

15. The safety cabinet of claim 10, wherein the safety cabinet includes a retaining system to selectively retain the door in the open position.

16. The safety cabinet of claim 15 wherein the retaining system includes first and second fusible links, the fusible links mounted between the enclosure and the first and second doors, respectively, the fusible links being constructed such that the fusible links will fuse when the ambient temperature is above a selected level to thereby detach the links from the enclosure to allow the closure system to the move the doors to the closed position.

17. The safety cabinet as described in claim 1, wherein the lock bar is made of steel bar stock.

18. The safety cabinet as described in claim 1, wherein lock bar is a color that contrasts with the color of the remainder of the safety cabinet.

19. The safety cabinet as described in claim 1, further comprising a base upon which the enclosure is mounted, the base including a pair of forklift pockets which extend through the base.

20. A safety cabinet comprising:
an enclosure defining an opening, the enclosure having a front, a back, a top, a bottom, a first side, and a second side;
a base upon which the enclosure is mounted, the base including a pair of forklift pockets which extend through the base;
a first door rotatably attached to the enclosure, the door movable between an open position and a closed position;
a second door rotatably attached to the enclosure, the door movable between an open position and a closed position, the first and second doors, when in the closed position, cooperating with each other to cover the opening of the enclosure;
a first retaining arm attached to the first side of the enclosure so that a portion extends from the front of the enclosure, wherein the protruding portion includes a notch and a hole;
a second retaining arm attached to the second side of the enclosure so that a portion extends from the front of the enclosure, wherein the protruding portion includes a notch and a hole;
a first lock;
a second lock;
a removable lock bar that can be placed transversely across the front of the safety cabinet so that it rests on the retaining arms, the lock bar including:
a rigid body that has a top, a bottom, a front, a back, a first distal end, a second distal end, the bar defining a first notch and a second notch, the bar being configured so that when the lock bar is put on the safety cabinet the first notch will engage the notch of the first retaining arm, the second notch will engage the notch of the second retaining arm, the body including a first hole near the first end and a second hole near the second end,
wherein, while in retentive engagement with the first and second retaining arms, the lock bar will prevent the doors from being moved from the closed position, and
wherein, while in retentive engagement with the first and second retaining arms, the first hole of the lock bar aligns with the hole of the first retaining arm so that the first lock is extendible through the aligned holes and the second hole in the lock bar aligns with the hole of the second retaining arm so that the second lock is extendible through the aligned holes;
a latching system to automatically latch both the cabinet doors in the closed position;
a handle for operating the latching system located on the first cabinet door, the lock bar preventing the operation of the handle when the lock bar is in place on the safety cabinet;
a closure system operably arranged with the doors to bias the doors to the closed position; and
a retaining system to selectively retain the doors in the open position, wherein the retaining system includes first and second fusible links, the fusible links mounted between the enclosure and the first and second doors, respectively, the fusible links being constructed such that the fusible links will fuse when the ambient temperature is above a selected level to thereby detach the links from the enclosure to allow the closure system to the move the doors to the closed position.

21. The safety cabinet as described in claim 19, the safety cabinet further comprising:
a first lock bar support attached to an outside surface of the first cabinet door, the first lock bar defining a notch;
a second lock bar support attached to an outside surface of the second cabinet door, the second lock bar defining a notch; and
wherein the lock bar includes a first interior notch and a second interior notch, the interior notches mating with the notches of the first lock bar support and the second lock bar support, respectively, when the lock bar is in place on the safety cabinet.

22-30. (canceled)
